SEQUENCE LISTING (2 sequences)

SEQ ID NO: 1 - protein, 4106 aa, Artificial
  Exemplary sequence used to illustrate invention.
XXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXCXXXXXXXXXCCXXXXXXXXXXXXXXXXXXXXXXXXXXXXXXXXXXXXXXXCXXXXXXXXXXXXXXXXXXXXXXXCXXXXXXXXXCCXXXXXXXXXXXXXXXXXXCXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXX

SEQ ID NO: 2 - protein, 4368 aa, Artificial
  Exemplary sequence used to illustrate invention.
XXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXCXXXXXXXXXXXXXXXXXXXXXXXXXXXXXXXXXXXXXXXXXXXXXXXXXXCXXXXXCXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXCXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXCXXXXXXXXXXXXXXXXXXXXXXXXXXXXXXXXXXXXXXXXXXXXXXXXXXCXXXXXCXXXXXXXXXXXXXXXXXXXXXXXXXXXXXXXXXXXXXXXXXXXXXXXXXXCXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXX

(19) United States
(12) Patent Application Publication
(10) Pub. No.: US 2014/0170292 A1
(43) Pub. Date: Jun. 19, 2014

(54) STABILIZED AERATED CONFECTION CONTAINING HYDROPHOBIN

(71) Applicant: Conopco, Inc., d/b/a UNILEVER, Englewood Cliffs, NJ (US)

(72) Inventors: Andrew Richard COX, Bedford (GB); Nicholas David HEDGES, Towcester (GB); Damiano ROSSETTI, Kettering (GB); Penelope Eileen KNIGHT, Raunds (GB)

(73) Assignee: Conopco, Inc., d/b/a UNILEVER, Englewood Cliffs, NJ (US)

(21) Appl. No.: 14/182,452

(22) Filed: Feb. 18, 2014

Related U.S. Application Data
(63) Continuation-in-part of application No. 13/585,257, filed on Aug. 14, 2012.

(51) Int. Cl. A23G 3/52

(52) U.S. Cl. CPC A23G 3/52
USPC 426/564

(57) ABSTRACT

A chill, ambient or frozen aerated confection is disclosed whose microstructure is stable to temperature abuse for the frozen case or storage for the chill or ambient case. A synergistic stabilization effect regarding the combination of hydrophobin, a Secondary protein and a Co-surfactant is described that results in the observed stabilization.

### CROSS-REFERENCE TO RELATED APPLICATIONS

This application is a continuation-in-part of application Ser. No. 13/585,257, filed Aug. 14, 2012.

### BACKGROUND OF THE INVENTION

1. Field of the Invention

The present invention relates to the production of an aerated chilled, ambient or frozen confectionery comprising of hydrophobin, a Secondary protein, and a Co-surfactant (CSF).

2. Background of the Art

It is desirable to make small size bubbles in aerated frozen confections that are stable to temperature abuse in order to improve texture, palatability, and reduce calorific content. It is well understood that frozen confections such as sorbets, sherbets and ice cream experience temperature fluctuations in the distribution chain and in consumers' home freezers. This results in bubble growth and a degradation of the product quality and the palatability on consumption. It is preferable to produce an ice cream with stable bubbles. It is also desirable to make small size, stable bubbles in aerated chill and ambient confections that are stable to long term storage in order to improve texture, palatability, and reduce caloric content. It is well understood that bubble growth, loss of air and separation of the aerated chill and ambient product cause a degradation of the product quality and the palatability on consumption. It is preferable to produce an aerated chill and ambient product with stable bubbles.

US Patent publication no. 2006024417A, published on Feb. 2, 2006 to Berry et al. discloses aerated products comprising hydrophobin where the hydrophobin is used to inhibit bubble coarsening.

US Patent publication no. 2008213453A published on Sep. 4, 2008 to Burmester et al. discloses aerated food products and methods producing them, where in the product comprises hydrophobin and a surfactant.

We have unexpectedly found that when the combination of hydrophobin, at least one Secondary protein and at least one Co-surfactant (as those terms are defined below) are used to make in one preferred embodiment an aerated frozen confectionery product and in another preferred embodiment, a chill or ambient confectionery product then:

The microstructure of the freshly produced product is preferable since the air bubbles sizes are generally smaller augmenting the beneficial qualities described above.

The microstructure of the product after storage and temperature abuse of the frozen product is preferable since the air bubbles sizes are more stable and do not grow (coarsen) to the same extent as comparative cases.

### BRIEF DESCRIPTION OF THE INVENTION

In one aspect of the invention is a frozen, chill or ambient aerated food composition including but not limited to:
a. at least 0.01 wt. % of total hydrophobin(s) selected from the group consisting of HFBII, HFBI car Cerato Ulmin or blends thereof added in isolated form to the food composition;
b. one or more Co-surfactants in the total concentration range of about 0.001 to less than about 0.3 wt. % (preferably less than about 0.1 or 0.2 wt. %), and the Co-surfactant(s) to total hydrophobin wt. ratio is in the range of about 0.02 to less than 1.0. (Preferably the Co-surfactant to hydrophobin wt. ratio is at least about 0.05, more preferably at least about 0.3 and preferably at most about 0.75); and
c. one or more Secondary protein(s) that are different from hydrophobin(s); wherein said Secondary protein(s) are present in a total concentration range of about 0.25 to less than 6.0 wt. % (Preferably the total Secondary protein(s) are at least 0.5 or 1.0 wt. % and at most 4 or 5 wt. %).

In another aspect of the invention is a process of making an aerated food composition including but not limited to the steps of:
a. Blending the food composition ingredients together and mixing;
b. Adding hydrophobin and a Co-surfactant or Co-surfactants to the chilled mix of step (a);
c. Aerating and optionally freezing the of step (b) to produce the aerated product; and in the case of the frozen product;
d. Cooling the product to a storage temperature of less than about −15 C. and
e. wherein pasteurisation may be accomplished after step (a) and/or step (b).

### BRIEF DESCRIPTION OF THE DRAWINGS

FIG. 1 is a graphical representation of Elastic modulus for Example 1, samples A) HFBII, (B) HFBII+SMP and (C) HFBII+SMP+CSF (TWN20) at 5° C. as a function of time.

FIG. 2 depicts SEM images for Example 1, HFBII (a, d), HFBII+SMP (b, e) and HFBII+SMP+CSF (TWN20) (c, f) for ice cream formulations described in Table 2. Images show fresh samples (a to c) and after the storage test (d to f), which includes the standard temperature abuse protocol.

FIG. 3 depicts SEM images of comparative samples containing 0.02 wt. % Tween 60 (a, d), 0.02 wt. % Erythritol (b, e), and 0.03 wt. % Hygel (c, f). All samples include HFBII (0.2 wt. %)+SMP (8.22 wt. %)+comparative surfactant at concentration indicated. Images show fresh samples (a to c) and after the storage test (d to f), which includes the standard temperature abuse protocol. Samples correspond to equivalent model formulations described in Table 3.

FIG. 4 depicts SEM images of inventive samples containing 0.02 wt. % Tween 20 (a, d), 0.06 wt. % Tween 60 (b, e), and 0.02 wt. % PGE-O-80 (c, f). All samples include HFBII (0.2 wt. %)+SMP (8.22 wt. %)+inventive surfactant at concentration indicated. Images show fresh samples (a to c) and after the storage test (d to f), which includes the standard temperature abuse protocol. Samples correspond to equivalent model formulations described in Table 3.

FIG. 5: is a graphical representation of Elastic modulus for HFBI class II, HFBI class II+SMP and HFBI class II+SMP+CSF (TWN20) at 5° C. for indicated concentrations as a function of time.

FIG. 6: is a graphical representation of Elastic modulus for CU class II, CU class II+SMP and CU class II+SMP+CSF (TWN20) at 5° C. for indicated concentrations as a function of time.

FIG. 7 shows a schematic depiction of a micrograph illustrating the guard frame concept for bubble size measurement.

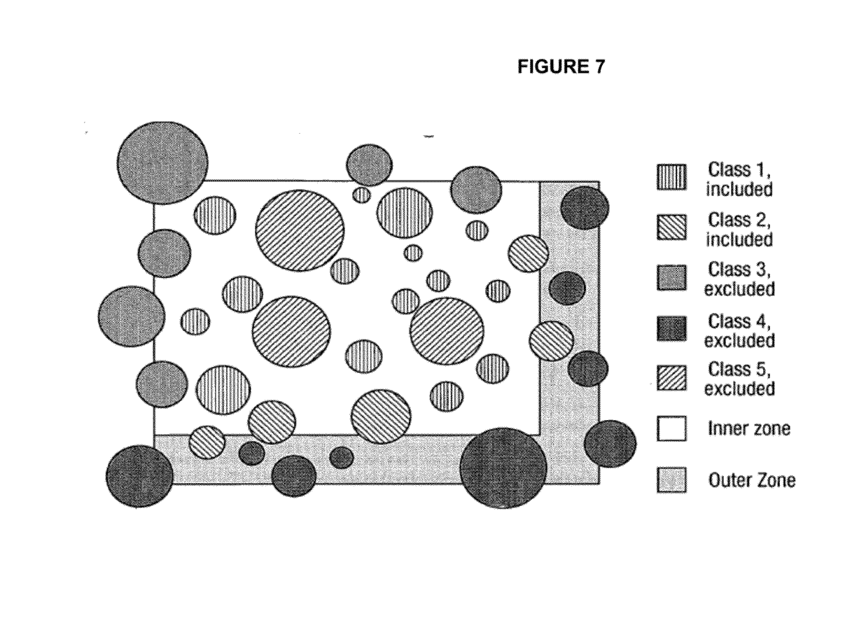

FIG. 8a depicts macroscope images of the fresh products D (0.02% Tween 20), E (0.02% Tween 60), and F (0.02% Panodan) described in Example 7. Also shown is an image for the comparative control sample (labelled Cont).

FIG. 8b depicts macroscope images of the chill stored products D, E, and F described in Example 7. Also shown is an image for the comparative control sample (labelled Cont).

FIG. 9 depicts the variation of dilational elastic modulus with time for HFBII, HFBII+SMP and HFBII+SMP+co-surfactant mixtures of Example 8.

FIG. 10 depicts a photograph of the aerated product prepared using a level of Co-surfactant that is outside of the invention.

### DETAILED DESCRIPTION OF THE INVENTION

In one aspect of the invention is a chill, ambient frozen aerated food composition including but not limited to:
a. at least 0.01 wt. % of total hydrophobin(s) selected from the group consisting of HFBII, HFBI or Cerato Ulmin or blends thereof added in isolated form to the food composition;
b. one or more Co-surfactants in the total concentration range of about 0.001 to less than about 0.2 wt. % (preferably less than about 0.1%), and the Co-surfactant(s) to total hydrophobin wt. ratio is in the range of about 0.02 to about 1.0. (Preferably the Co-surfactant to hydrophobin wt. ratio is at least about 0.05, more preferably at least about 0.3 and preferably at most about 0.75); and
c. one or more Secondary protein(s) that are different from hydrophobin(s); wherein said Secondary protein(s) are present in a total concentration range of about 0.25 to less than 6.0 wt. % (Preferably the total Secondary protein(s) are at least 0.5 or 1.0 wt. % and at most 4 or 5 wt. %).

Advantageously the total hydrophobin(s) concentration is at most 1.5 wt. %. Preferably the Co-surfactants is or are water soluble non-ionic surfactant(s). More preferably the Co-surfactant(s) are selected from Polysorbates, polyglycerol esters of alkyl or alkenyl fatty acids, diacetyl tartartic acid esters of mono-/di-glycerides, sucrose esters with an HLB>about 8 or blends thereof. Most preferably the Co-surfactant(s) has a minimum effective HLB value of about 8. Effective HLB value is here defined as the arithmetic mean of the HLB values of a blend of Co-surfactants. Advantageously the Co-surfactant(s) is selected from Tweens 20, 60 or 80, PGE-O-80; Panodan-Visco Lo 2000 and blends thereof.

In the case of the frozen embodiment, preferably the average bubble diameter (d3, 2) is at least 10% smaller after the standard temperature abuse protocol described below than the same product prepared the same way but absent either hydrophobin(s), Co-surfactant(s) or if both are present then outside the total Co-surfactant(s) to hydrophobin(s) ratio range of about 0.02 to less than 1.0. Preferably the average bubble size is at least 20, 30, 40 or 50% smaller.

Preferably the average bubble diameter d(3, 2) of the freshly prepared frozen product stored at below about −15° C. and pre-temperature abuse is at least 10% smaller, preferably 15% smaller, and more preferably 20% smaller than the same product prepared the same way but absent either hydrophobin(s), Co-surfactant(s) or if both are present then outside the total Co-surfactant(s) to hydrophobin(s) ratio range of about 0.02 to less than 1.0.

In the case of the chill or ambient embodiment, preferably after 6 weeks storage at 5 C no more than 10 bubbles, preferably no more than 7 bubbles, more preferably no more than 5 bubbles and most preferably no more than 3 bubbles of a size greater than 10 mm in diameter are observed in a sample size of 9437 mm squared area where the sample is in a 6 mm deep container and had an initial overrun between 30 and 200% overrun, more preferably between 50 and 150% overrun.

In another aspect of the invention is a process of making an aerated food composition including but not limited to the steps of:
a. Blending the food composition ingredients together and mixing;
b. adding hydrophobin and a Co-surfactant or Co-surfactants to the chilled mix of step (a);
c. Aerating and in the case of the frozen product, freezing the mix of step (b) to produce the aerated and frozen product; and
d. Optionally further ingredients could be added after aeration for the chill, and ambient case
e. For the frozen product, cooling the frozen product to a storage temperature of less than about −15 C and;
f. wherein pasteurisation may be accomplished after step (a) and/or step (b).

Preferably for the frozen product the process further includes the step of extruding the frozen product from a freezer at a temperature of about −5 C or less.

All percentages, unless otherwise stated, refer to the percentage by weight, with the exception of percentages cited in relation to the overrun.

### Confections

The term “chill or ambient or frozen confection” means an edible confection made by a mix of ingredients which includes water. Such confections typically contain fat, non-fat milk solids and sugars, together with other minor ingredients such as stabilisers, emulsifiers, colours and flavourings. Frozen confections include ice cream, water ice, frozen yoghurt, sherbets, sorbet and the like. Chill or ambient confections include mousses, desserts, yoghurts, milk shakes and the like.

### Aeration

The term aeration means that gas has been incorporated into a product to form air cells. The gas can be any gas but is preferably, particularly in the context of food products, a food-grade gas such as air, nitrogen or carbon dioxide or a mixture of the aforementioned. The extent of the aeration can be measured in terms of the volume of the aerated product. The stability of the aeration can be assessed by monitoring the volume of the aerated product over time and or the bubble size change over time.

### Microstructure

The microstructure of chill and ambient or frozen confections is critical to their organoleptic properties. The air cells incorporated into confections are preferably small in size which ensures that the confections do not have a coarse texture and also ensures that they deliver a smooth creamy mouth-feel. In typical aerated products, the air bubbles coarsen over time (through distribution and storage) leading to a degradation in quality.

### Chill Product

A chill product is one that is typically distributed and stored at temperatures between 0° C. and 10° C.

### Ambient Product

An ambient product is one that is typically distributed and stored at temperatures between 15° C. and 40° C., and more preferable at temperatures between 15° C. and 30° C.

### Hydrophobins

Hydrophobins are a well-defined class of proteins (Wessels, 1997, Adv. Microb. Physio. 38: 1-45; Wosten, 2001, Annu Rev. Microbial 55: 625-646) capable of self-assembly at a hydrophobic/hydrophilic interface, and having a conserved sequence:

(SEQ ID No. 1)
Xₙ-C-X₅₋₉-C-C-X₁₁₋₃₉-C-X₈₋₂₃-C-X₅₋₉-C-C-X₆₋₁₈-C-Xₘ

where X represents any amino acid, and n and m independently represent an integer. Typically, a hydrophobin has a length of up to 125 amino acids. The cysteine residues (C) in the conserved sequence are part of disulphide bridges. In the context of the present invention, the term hydrophobin has a wider meaning to include functionally equivalent proteins still displaying the characteristic of self-assembly at a hydrophobic-hydrophilic interface resulting in a protein film, such as proteins comprising the sequence:

(SEQ ID No. 2)
Xₙ-C-X₁₋₅₀-C-X₀₋₅-C-X₁₋₁₀₀-C-X₁₋₁₀₀-C-X₁₋₅₀-
C-X₀₋₅-C-X₁₋₅₀-C-Xₘ

or parts thereof still displaying the characteristic of self-assembly at a hydrophobic-hydrophilic interface resulting in a protein film. In accordance with the definition of the present invention, self-assembly can be detected by adsorbing the protein to Teflon and using Circular Dichroism to establish the presence of a secondary structure (in general α-helix) (De Vocht et al, 1998, Biophys. J. 74: 2059-68).

The formation of a film can be established by incubating a Teflon sheet in the protein solution followed by at least three washes with water or buffer (Wosten et al., 1994, Embo. J. 13: 5848-54). The protein film can be visualised by any suitable method, such as labeling with a fluorescent marker or by the use of fluorescent antibodies, as is well established in the art. m and n typically have values ranging from 0 to 2000, but more usually m+n<100 or 200. The definition of hydrophobin in the context of the present invention includes fusion proteins of a hydrophobin and another polypeptide as well as conjugates of hydrophobin and other molecules such as polysaccharides.

Hydrophobins identified to date are generally classed as either class I or class II Both types have been identified in fungi as secreted proteins that self-assemble at hydrophobilic interfaces into amphipathic films. Assemblages of class I hydrophobins are relatively insoluble whereas those of class II hydrophobins readily dissolve in a variety of solvents.

Hydrophobin-like proteins have also been identified in filamentous bacteria, such as Actinomycete and Streptomyces sp. (WO01/74864). These bacterial proteins, by contrast to fungal hydrophobins, form only up to one disulphide bridge since they have only two cysteine residues. Such proteins are an example of functional equivalents to hydrophobins having the conserved sequences shown in SEQ ID Nos. 1 and 2, and are within the scope of the present invention.

The hydrophobins can be obtained by extraction from native sources, such as filamentous fungi, by any suitable process. For example, hydrophobins can be obtained by culturing filamentous fungi that secrete the hydrophobin into the growth medium or by extraction from fungal mycelia with 60% ethanol. It is particularly preferred to isolate hydrophobins from host organisms that naturally secrete hydrophobins. Preferred hosts are hyphomycetes (e.g. Trichoderma), basidiomycetes and ascomycetes. Particularly preferred hosts are food grade organisms, such as Cryphonectria parasitica which secretes a hydrophobin termed cryparin (MacCabe and Van Alfen, 1999, App. Environ. Microbial. 65: 5431-5435).

Alternatively, hydrophobins can be obtained by the use of recombinant technology. For example host cells, typically micro-organisms, may be modified to express hydrophobins and the hydrophobins can then be isolated and used in accordance with the present invention. Techniques for introducing nucleic acid constructs encoding hydrophobins into host cells are well known in the art. More than 34 genes coding for hydrophobins have been cloned, from over 16 fungal species (see for example WO96/41882 which gives the sequence of hydrophobins identified in Agaricus bisporus; and Wosten, 2001, Annu Rev. Microbiol. 55: 625-646). Recombinant technology can also be used to modify hydrophobin sequences or synthesise novel hydrophobins having desired/improved properties.

Typically, an appropriate host cell or organism is transformed by a nucleic acid construct that encodes the desired hydrophobin. The nucleotide sequence coding for the polypeptide can be inserted into a suitable expression vector encoding the necessary elements for transcription and translation and in such a manner that they will be expressed under appropriate conditions (e.g. in proper orientation and correct reading frame and with appropriate targeting and expression sequences). The methods required to construct these expression vectors are well known to those skilled in the art.

A number of expression systems may be used to express the polypeptide coding sequence. These include, but are not limited to, bacteria, fungi (including yeast), insect cell systems, plant cell culture systems and plants all transformed with the appropriate expression vectors. Preferred hosts are those that are considered food grade—‘generally regarded as safe’ (GRAS).

Suitable fungal species, include yeasts such as (but not limited to) those of the genera Saccharomyces, Kluyveromyces, Pichia, Hansenula, Candida, Schizo saccharomyces and the like, and filamentous species such as (but not limited to) those of the genera Aspergillus, Trichoderma, Mucor, Neurospora, Fusarium and the like.

The sequences encoding the hydrophobins are preferably at least 80% identical at the amino acid level to a hydrophobin identified in nature, more preferably at least 95% or 100% identical. However, persons skilled in the art may make conservative substitutions or other amino acid changes that do not reduce the biological activity of the hydrophobin. For the purpose of the invention these hydrophobins possessing this high level of identity to a hydrophobin that naturally occurs are also embraced within the term “hydrophobins”.

Hydrophobins can be purified from culture media or cellular extracts by, for example, the procedure described in WO01/57076 which involves adsorbing the hydrophobin present in a hydrophobin-containing solution to surface and then contacting the surface with a surfactant, such as Tween 20, to elute the hydrophobin from the surface. See also Collen et al., 2002, Biochim Biophys Acta. 1569: 139-50; Calonje at al., 2002, Can. J. Microbiol. 48: 1030-4; Askolin at al., 2001, Appl Microbiol Biotechnol. 57: 124-30; and De Vries et al., 1999, Eur J Biochem. 262: 377-85.

The hydrophobin used in the present invention can be a Class I or a Class II hydrophobin. Preferably, the hydrophobin used is a Class II hydrophobin. Most preferably, the hydrophobin used is HFBI, HFBII, or CU (cerato ulmin). The hydrophobin used can also be a mixture of hydrophobins, e.g. Class II hydrophobins HFBI and HFBII.

The product should comprise at least 0.01 wt. % hydrophobin, more preferably at least 0.025 wt. % hydrophobin and most preferably at least 0.05 wt. %. Preferably the hydrophobin is present in an amount of 1.5 wt. % maximum and more preferably 0.5 wt. % maximum and most preferably 0.2 wt. % maximum.

### Overrun

The extent of aeration of a product is measured in terms of “overrun”, which is defined as

$$\% Overrun = \frac{weight of mix - weight of aerated product}{weight of aerated product} \times 100$$

Where the weights refer to a fixed volume of mix or product. Overrun is measured at atmospheric pressure.

Preferably the overrun of the product is between 10 and 400% overrun, more preferably between 10 and 300% overrun, and most preferably between 20 and 250% overrun. Preferably the measurements are taken immediately after aeration is ended.

### Dilational Interfacial Rheology

Interfacial or surface rheology, defines the functional relationship between stress, deformation and rate of deformation at an interface in terms of coefficients of elasticity, and viscosity, arising from relaxation processes. The technique is referred to as dilational interfacial rheology when the experimentally imposed interfacial deformation arises from variation of area at constant shape. The investigation of the dilational rheology of adsorbed layers is useful to access the macroscopic viscoelastic properties of interfaces and can be used to predict the stability of a foam once formed.

In the dilational deformation mode, the use of the interfacial tension (γ) response to relative area variation (ΔA/A) provides for the definition of the dilational viscoelasticity. Assuming harmonic area perturbations of small amplitude of frequency ν, the dilational viscoelasticity can be written using a linear approximation approach, as

$$E = \frac{d γ}{d ln A}$$

where the viscoelastic modulus E can be further split into its elastic (Eₑ) and viscous (E_{ν}) components (see e.g. R. Miller, L. Liggieri, Interfacial Rheology, Brill, Leiden, 2009, Ch. 5, 138).

One criterion to reduce bubble coarsening (e.g. coalescence and/or disproportionation) is to confer adequate interfacial properties (particularly elasticity) to the air/water surface, i.e. the bubble surface. Experimental data show that high interfacial elasticity (for completely “elastic” interfaces) is able to slow down the rate of disproportionation (see e.g. W. Kloek, T. van Vliet, M. Meinders, J Colloi Interf Sci, 2001, 237, 158), and consequently this bubble/foam coarsening.

This criterion has been used here to predict the stability of fully formulated aerated frozen confections such as ice creams, stored under controlled thermal conditions, which includes a temperature abuse protocol. Verification of the stability of the ice cream was assessed using SEM (Scanning Electron Microscopy) and observations compared with predictions from the dilational interfacial rheology experiments.

### Co-Surfactants

A Co-surfactant (CSF) is defined as:

An ingredient which, when mixed in an aqueous solution containing:
0.001 wt. % hydrophobin
and between 0.0015 and 0.2 wt. % of at least one non-hydrophobin (Secondary) protein at a concentration effective to confer an air/water surface dilatational elasticity that is at least 30% of that of 0.001 wt. % pure hydrophobin (absent the Co-surfactant), more preferably at least 50%, more preferably at least 55%, more preferably at least 65% and most preferably at least 70%, measured between 600 and 7200 s at 5° C. for an air droplet in water subject to a continuous area change of between 2.5 and 3.5% oscillated at a frequency of 0.05 Hz using the procedure provided below. The effective concentration will depend on the identity of the Co-surfactant. Preferably the effective concentration will be in the range of 0.001 to less than 0.2 wt. % based on the product; more preferably in the range of 0.005 to 0.2 wt. % and most preferably in the range of 0.01 to 0.1 wt. %.

Preferably the Co-surfactant is chosen as one of more of the following:
E.g. Polysorbates, including Polysorbate 20, 60 and/or 80 also known as Tween 20, 60, and 80 or Polyoxyethylene (20) sorbitan monolaurate, Polyoxyethylene (60) sorbitan monolaurate and Polyoxyethylene (80) sorbitan monolaurate respectively.
Polyglycerol esters of fatty acids, particularly PGE-O-80 as supplied by Danisco
Diacetyl tartartic acid esters of mono-/di-glycerides, particularly Panodan Visco-Lo 2000as supplied by Danisco
Sucrose esters of HLB>8 or 12 (HLBs of P70 and SE1670 are 15 and 16, respectively)

### Secondary Protein(s)

Secondary protein(s) are defined as non-hydrophobin proteins that when mixed with 0.001 wt. % hydrophobin in aqueous solution at a concentration of 0.04 wt. % results in an air/water surface dilatational elasticity that is at least 35% less than that of hydrophobin alone, more preferably at least 40% less, more preferably at least 50% less, where the dilatational measurement is made between 600 and 4000 s at 5° C. for an air droplet in water subject to a continuous area change of between 2.5 and 3.5% oscillated at a frequency of 0.05 Hz. Secondary proteins, are advantageously chosen from food proteins such as: skim milk protein (SMP), whey protein, soy protein, or mixtures thereof and the like.

It may be noted that many Secondary proteins such as skim milk powder are not typically received and used as pure proteins, since they consist of other ingredients such as lactose and other non-protein materials. Therefore the protein content must be taken into account during formulation.

### Other Product Ingredients

Further additional ingredients are typically added to make the inventive confectionary product(s) These include and are not restricted to:

Sugars, e.g. sucrose, fructose, dextrose, corn, syrups and sugar alcohols and the like. Fats, e.g. coconut oil, butter oil, palm oil and the like. Preferably the fat content of the product is less than 5 wt. %, more preferably less than 3 wt. %, more preferably less than 2 wt. %, most preferably less than 1.5 wt. %, 1.0, 0.5, 0.4, 0.3, 0.2, 0.1, 0.01, 0.001 wt. % or zero.

Emulsifiers, e.g. mono/di glycerides of fatty acids and the like other than Co-surfactants.

Stabilisers or thickeners, e.g. locust bean gum, guar gum, tars gum, carrageenans, alginates, pectins, citrus fibres, xanthan, gelatine and the like.

Flavours and colours, e.g. vanilla, fruit purees, chocolate, mint and the like.

The invention will now be described in greater detail by way of the following non-limiting examples. The examples are for illustrative purposes only and not intended to limit the invention in any way. Physical test methods are described below:

Except in the operating and comparative examples, or where otherwise explicitly indicated, all numbers in this description indicating amounts or ratios of materials or conditions or reaction, physical properties of materials and/or use are to be understood as modified by the word “about”.

Where used in the specification, the term “comprising” is intended to include the presence of stated features, integers, steps, components, but not to preclude the presence or addition of one or more features, integers, steps, components or groups thereof.

All percentages in the specification and examples are intended to be by weight unless stated otherwise

### EXAMPLES

### Example 1

### Surface Dilatational Rheology Measurements to Demonstrate the Effect of One Inventive Co-Surfactant

Surface dilatational rheology measurements were taken using formulations A, B, and C shown in Table 1.

TABLE 1
Formulations used for Example 1.

| | wt. % | | |
|---|---|---|---|
| Ingredient | A (reference) | B (comparative) | C (inventive) |
| HFBII | 0.001% | 0.001% | 0.001% |
| SMP * | — | 0.041% | 0.041% |
| Co-surfactant | — | — | 0.0001% |
| Tween 20 | | | |

* Concentration for SMP (skim milk powder) is that stated for the total powder. The amount of protein in SMP was stated by the manufacturer as 35 wt. %

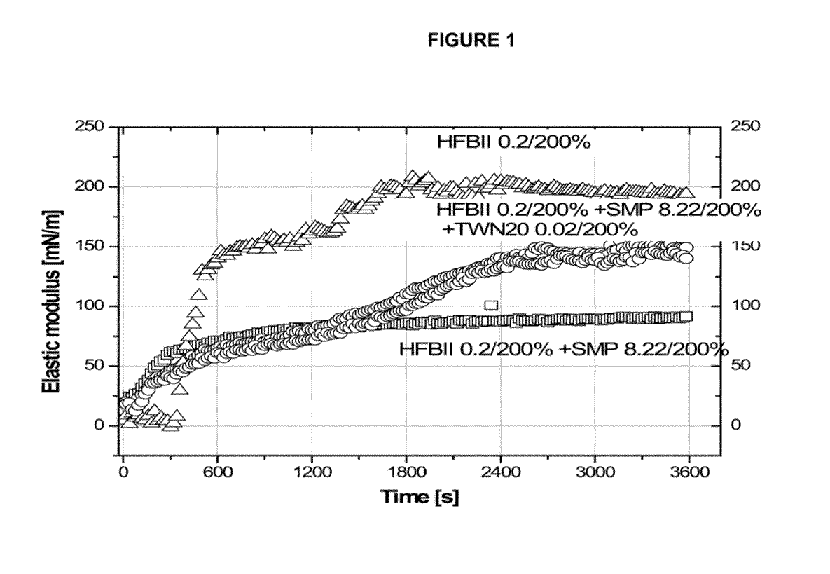

The elastic modulus data are summarised in FIG. 1. We can appreciate the unexpectedly different effects of adding SMP or SMP+Co-surfactant (Tween20) to HFBII at the indicated concentrations. Addition of SMP (squares, Example 1B) clearly reduces the elastic interfacial modulus of HFBII (triangles, Example 1A). Addition of Co-surfactant (circles Example 1C) to the SMP+HFBII mix promotes a recovery of the interfacial elasticity that is substantially different than the comparative case i.e. HFBII+SMP.

This recovery is preferred since it will lead to a more stable foam structure in an aerated frozen confectionery where the ratio of HFBII: Co-surfactant: SMP is similar to that described in this example, although the absolute concentrations will be greater in order to make the food product.

### Example 2

### Aerated Frozen Products

Frozen aerated (ice cream) products (A), (B), and (C) were made using formulations summarised in Table 2. The relative amounts of hydrophobin, SMP, and Tween 20 Co-surfactant are the same as the equivalent examples measured in Example 1 (A, B, C),

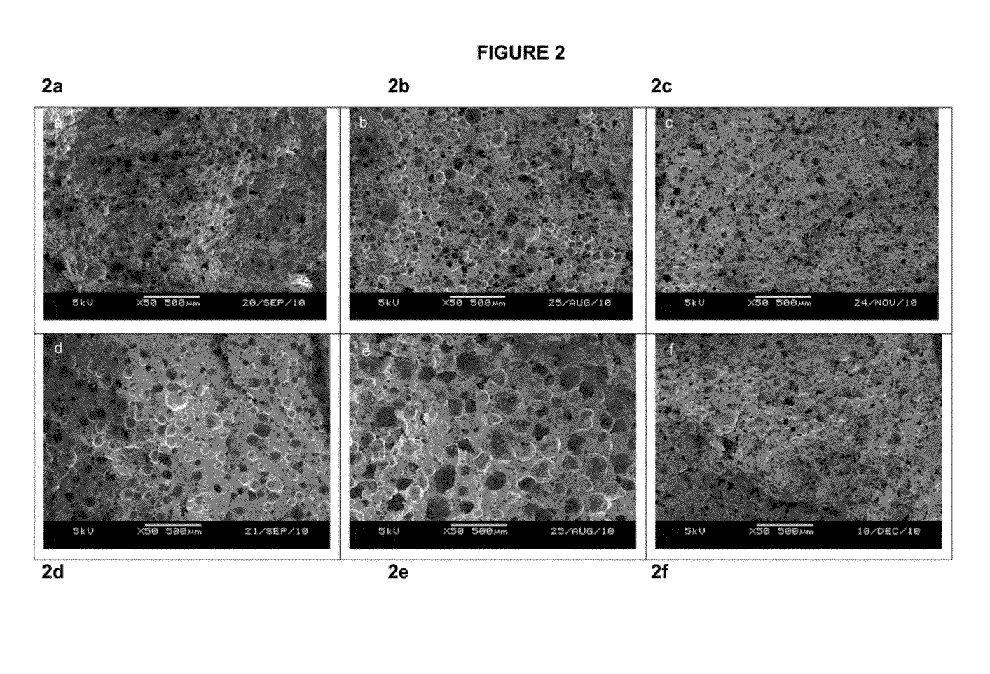

TABLE 2
Formulation of ice cream for SEM images shown in FIG. 2.

| | Wt. % | | |
|---|---|---|---|
| Ingredients | A | B | C |
| Sucrose | 11.5% | 11.5% | 11.5% |
| Corn syrup | 10.0% | 10.0% | 10.0% |
| Locust Bean | 0.3% | 0.3% | 0.3% |
| Gum | | | |
| Guar Gum | 0.1% | — | — |
| SMP | — | 8.22% | 8.22% |
| Water | 67.9% | 69.78% | 69.76% |
| post addition | | | |
| HFBII | 0.2% | 0.2% | 0.2% |
| Co-surfactant | — | — | 0.02% |
| Tween 20 | | | |

The microstructures of the fresh and temperature abused products for A, B, and C, are shown in the SEM images depicted in FIG. 2. From these images it can be seen that: Product B (FIG. 2b) has a larger air bubble size (diameter) distribution than A (FIG. 2a) or C (FIG. 2c) for the freshly prepared sample. Product B bubbles (FIG. 2e) also coarsen (or grow) more than A (FIG. 2d) or C (FIG. 2f) after temperature abuse using the method described below. Hence, after temperature abuse, Product B has the poorest microstructure. Further assessment of the microstructure via quantifying the bubble size changes between the fresh and the temperature abused samples can be determined by, for example, image analysis of the SEM micrographs as discussed below.

Inventive Product C with added Co-surfactant has the smallest air bubbles for the fresh sample (FIG. 2c). It also unexpectedly had the smallest air bubbles after temperature abuse (FIG. 2f).

It was found that the recovery of the elastic modulus for the inventive Co-surfactant containing solution (Example 1C) was associated with the improved microstructure and stability of the formed ice cream (Example 2C), as observed from SEM images shown in FIG. 2f.

### Example 3

### Surface Dilatational Modulus for a Range of Hydrophobin, Skim Milk Protein, and Co-Surfactant Comparative and Inventive Cases

Evaluating the extent of the recovery (if any) of the elastic modulus (Eₑₗ) in presence of a Co-surfactant over the comparative hydrophobin+SMP case (e.g. Example 1B) is a method that was found useful to predict the quality of the ice cream microstructure after the temperature abuse storage test.

The elasticity of the a/w (air/water) interface in presence or absence of a Co-surfactant can be listed at set time points (e.g. 1200 s, 1800 s, 2400 s, 3600 s) and compared with the elasticity (absolute and percentage) of reference hydrophobin example alone (measured at 3600 s).

Elasticity of HFBII (0.001 wt. %) measured after 3600 s is 212.9±19.4 mN/m (average of five repetitions)—referring to solution in Example 1A, and illustrated in FIG. 1.

TABLE 3
Elastic modulus (mN/m) compared at defined time points for HFBII(0.001 wt.
%) + SMP (0.0411 wt. %) + either inventive Co-surfactant or a comparative surfactant (at
indicated concentration). Parenthetical expressions indicate percentage (%) of HFBII (0.001 wt.
%) elastic modulus (219 mN/m = 100%) measured at 3600 s

| Inventive Co- | | | | | | |
|---|---|---|---|---|---|---|
| surfactant or | | | | | | |
| comparative | | | | | | |
| surfactant | | | | | | |
| (wt. %) | 1200 s | 1800 s | 2400 s | 3600 s | replicates | Notes |
| NONE (Comp.) | 84.3 (39.6%) | 87.0 (40.08%) | 90.2 (42.3%) | 93.6 (43.9%) | 2 | |
| Tween 20 (Inv.) | 76.8 (36.0%) | 86.9 (40.8%) | 104.6 (49.1%) | 138.8 (65.2%) | 3 | |
| (0.00005 wt. %) | | | | | | |
| Tween 20 (Inv.) | 72.2 (33.9%) | 97.4 (45.7%) | 127.4 (59.8%) | 139.0 (65.2%) | 4 | |
| (0.0001 wt. %) | | | | | | |
| Tween | 91.2 (42.8%) | 89.3 (41.9%) | 113.6 (53.3%) | 146.5 (68.8%) | 2 | |
| 20(Inv.) | | | | | | |
| (0.00015 wt. %) | | | | | | |
| Tween | 63.5 (29.8%) | 71.2 (33.4%) | 78.1 (36.6%) | 90.2 (42.3%) | 1 | |
| 60(Comp.) | | | | | | |
| (0.0001 wt. %) | | | | | | |
| Tween | 75.3 (35.4%) | 92.0 (43.2%) | 99.6 (46.8%) | 114.9 (54%) | 2 | |
| 60(Comp.) | | | | | | |
| (0.0002 wt. %) | | | | | | |
| Tween 60(Inv.) | 82.1 (38.5%) | 108.2 (50.8%) | 123.2 (57.8%) | | 2 | exp |
| (0.0003%) | | | | | | terminated |
| | | | | | | at |
| | | | | | | 2400 s |
| Tween | 68.9 (32.3%) | 80.1 (37.6%) | 98.7 (46.3%) | 124.1 (58.3%) | 3 | |
| 80 (Inv.) | | | | | | |
| (0.0001%) | | | | | | |
| PGE-O-80 (Inv.) | *119.5 (56.1%) | | | | 1 | exp |
| (0.0001 wt. %) | | | | | | terminated |
| Poly-glycerol | | | | | | at |
| Ester | | | | | | *900 s |
| PGE-O-80 (Inv.) | 114.5 (53.8%) | 126.3 (59.3%) | 121.1 (56.9%) | | 1 | exp |
| (0.00005 wt. %) | | | | | | terminated |
| Poly-glycerol | | | | | | at |
| Ester | | | | | | 2400 s |
| Panodan Visco | 25.7 (14.31%) | 56.5 (31.47%) | 95.8 (53.36%) | 148.7 (82.8%) | 1 | |
| Lo 2000 (Inv.) | | | | | | |
| (0.0002 wt. %) | | | | | | |
| Sucrose Ester | 60.5 (28.4%) | 109.1 (51.2%) | 129.2 (60.7%) | 152.4 (71.6%) | 1 | |
| SE1670 (Inv.) | | | | | | |
| (0.0002 wt. %) | | | | | | |
| Sucrose Ester | 59.7 (28.0%) | 71.3 (33.5%) | 83 (39%) | 124.7 (58.6%) | 2 | |
| SE1670 (Inv.) | | | | | | |
| (0.0001 wt. %) | | | | | | |
| Sucrose Ester | 57.9 (27.2%) | 62.7 (29.5%) | 72.8 (34.2%) | 102.4 (48.1%) | 2 | |
| SP70 (Comp.) | | | | | | |
| (0.0001 wt. %) | | | | | | |
| Erythritol | 80.5 (37.8%) | 85.7 (40.2%) | 89.2 (41.8%) | 94.9 (44.5%) | 1 | |
| (Comp.) (0.0001 wt. | | | | | | |
| %) | | | | | | |
| PGE55 (Comp.) | 61.1 (28.7%) | 65.5 (30.7%) | 67.3 (31.6%) | 75.8 (35.6%) | 2 | |
| (0.0001 wt. %) | | | | | | |
| Hygel (Comp.) | 74.8 (35.1%) | 79.0 (37.1%) | 79.9 (37.5%) | 81.1 (38.0%) | 1 | |
| (0.00015 wt. %) | | | | | | |

### Example 4

### Aerated Frozen Products

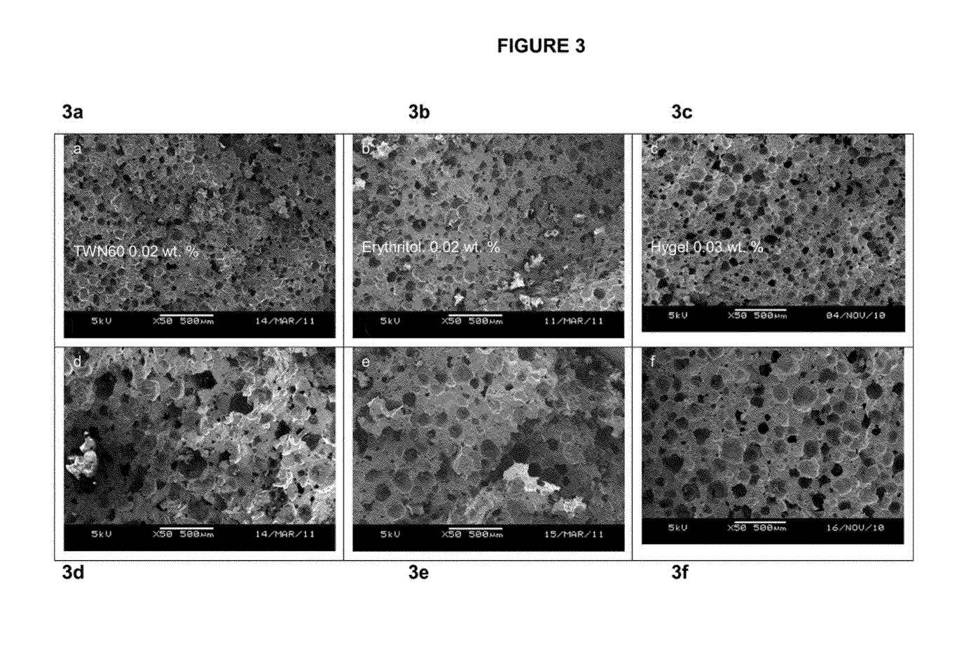

Aerated frozen products were produced using different examples of Co-surfactants. SEM images illustrated in FIG. 3 were produced for both fresh (FIGS. 3a, b, c) and temperature abused samples (FIGS. 3d, e, f). HFBII concentration was 0.2 wt. % and SMP concentration was 8.22 wt. %.

In all the comparative cases, after the temperature abuse protocol, the microstructure was observed to degrade (air bubbles visibly coarsened), as is also seen in the case when an inventive Co-surfactant is not present in the formulation (Example 2B and Example in FIG. 2e). This observation was surprisingly found to mirror the trend of the interfacial elastic modulus from interfacial rheology experiments on model formulations. In all cases, in fact, the elastic modulus (Table 3) stays at all time points below 45% of the value for HFBII alone (measured at 3600 s).

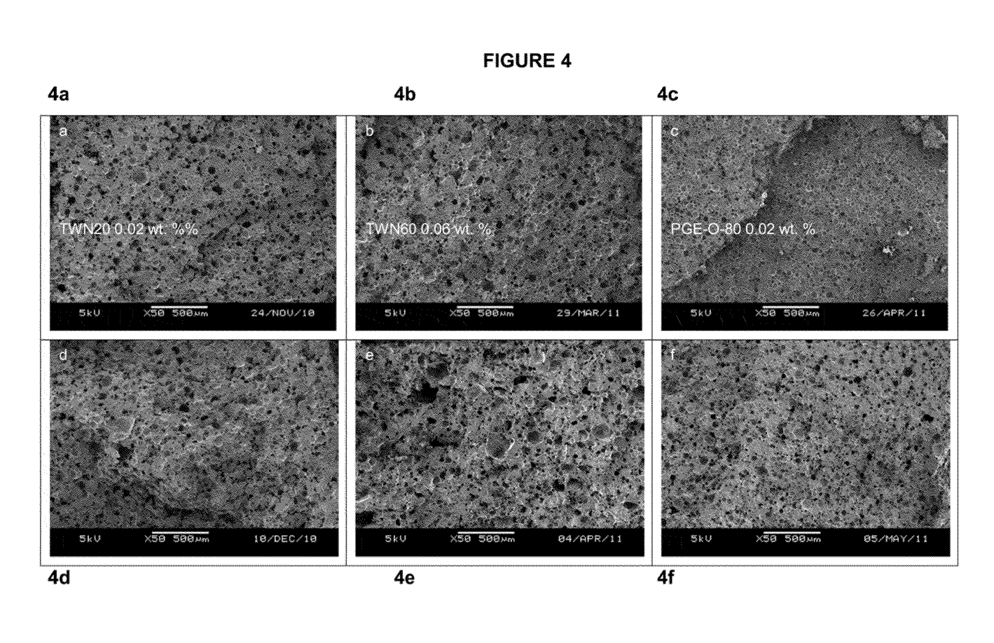

FIG. 4 shows SEM images of inventive Co-surfactant examples; 0.02 wt. % Tween 20, 0.06 wt. % Tween 60, and 0.02 wt. % PGE-O-80. In this case, we unexpectedly observed that the microstructure of the temperature abused ice cream (FIGS. 4d, e, f) samples has not degraded, in contrast to the case where the inventive Co-surfactant is not included (Example 2B and Examples in FIG. 2e and in FIGS. 3d, e, f). The beneficial effect is attributed to the presence of the Co-surfactant used. In these cases the elasticity (Table 3) of model formulations reaches, within the measured time points, at least over 55% of the value for HFBII alone (measured at 3600 s).

### Example 5

### Ice Cream Comprising Hydrophobia and a Co-Surfactant

Evaluation of the optimized level of Co-surfactant (Panodan) for aerated frozen products formulated at a 0.1 wt. % concentration HFBII and 11.3 wt. % SMP(Table 4) was carried out using the interfacial rheology technique on model formulations A, B, C and D (concentration reduced 200 times) shown in Table 5.

TABLE 4
Base Ice cream formulation

| | Wt. % |
|---|---|
| Ingredients | A |
| Sucrose | 11.5% |
| Maltodextrin 10 DE | 4.0% |
| SMP | 11.3% |
| Polydextrose | 5.25% |
| 36 DE Corn syrup solid | 5% |
| Coconut Oil | 0.15% |
| IcePro 2003 blend | 0.65% |
| Ice Structuring Protein | 0.0005% |
| Water | 66.1495 |
| post addition | |
| HFBII | 0.1% |
| Co-surfactant | To be optimized-see |
| Panodan Visco Lo 2000 | results summarised in |
| | Table 6. |

TABLE 5
Model interfacial rheology formulations used to determine optimum
amount of Co-surfactant for use in the ice cream formulation
stated in Table 4. Concentration for SMP (skim milk powder)
is that stated for the total powder. The amount of
protein in SMP was stated by the manufacturer as 35 wt. %.

| | Wt. % | | | |
|---|---|---|---|---|
| | A | B | C | D |
| Ingredient | (reference) | (comparative) | (comparative) | (inventive) |
| HFBII | 0.0005% | 0.0005% | 0.0005% | 0.0005% |
| SMP | — | 0.0565% | 0.0565% | 0.0565% |
| IcePro 2003 | — | 0.00325% | 0.00325% | 0.00325% |
| Co- | — | — | 0.00005% | 0.0002% |
| surfactant | | | | |
| Panodan | | | | |
| Visco | | | | |
| Lo 2000 | | | | |

### Results:

The results from the interfacial rheology experiments are summarised in Table 6. The data predict that the concentration of Panodan (CSF) to be ideally used in the ice cream example (Table 4) should be used in the ratio of 0.0005 wt. % HFBII: 0.0002 wt. % Panodan. The concentration used in the ice cream example was proposed as 0.1 wt. %. Therefore, the appropriate concentration of Panodan Co-surfactant should be preferably greater than 0.01% and preferably around 0.04 wt. %.

TABLE 6
Elastic modulus (mN/m) compared at defined time points for HFBII(0.0005 wt. %) +
SMP(0.0565 wt. %) + IcePro 2003 (0.00325 wt. %) + either inventive Co-surfactant or a
comparative surfactant (at indicated concentration). Parenthetical expression indicates
percentage (%) of HFBII (0.0005 wt. %) elastic modulus (179.5 mN/m = 100%, average of 2
repetitions) measured at 3600 s

| Inventive | | | | | | |
|---|---|---|---|---|---|---|
| Co- | | | | | | |
| surfactant | | | | | | |
| or | | | | | | |
| comparative | | | | | | |
| surfactant | 1200 s | 1800 s | 2400 s | 3600 s | replicates | Notes |
| NONE | 28.2 (15.7%) | 33.5 (18.6%) | 36.3 (20.2%) | *33.5 (18.6%) | 3 | *exp |
| (Comp.) | | | | | | terminated |
| | | | | | | at 3000 s |
| Panodan | 26.5 (14.7%) | 31 (17.7%) | 33.3% (18.5%) | 88.7% (49.4%) | 1 | |
| Visco Lo | | | | | | |
| 2000 | | | | | | |
| (Comp.) | | | | | | |
| (0.00005 wt. | | | | | | |
| %) | | | | | | |
| Panodan | 25.7 (14.3%) | 56.5 (31.4%) | 95.8 (53.3%) | *148.7 (82.8%) | 1 | *exp |
| Visco Lo | | | | | | terminated |
| 2000 (Inv.) | | | | | | at 3300 s |
| (0.0002 wt. | | | | | | |
| %) | | | | | | |

### Example 6

### Use of a Co-Surfactant with Class II Hydrophobin HFBI and CU in the Presence of Milk Protein

In the following section we show that the recovery of interfacial elastic modulus promoted by CSF is a common feature to different variants of class II hydrophobins. In this case, using either HFBI or CU, both of which are class II hydrophobins.

Surface dilational rheology experiments were carried out in the same manner as in the previous examples, except in these cases ΔA/A=2.5%.

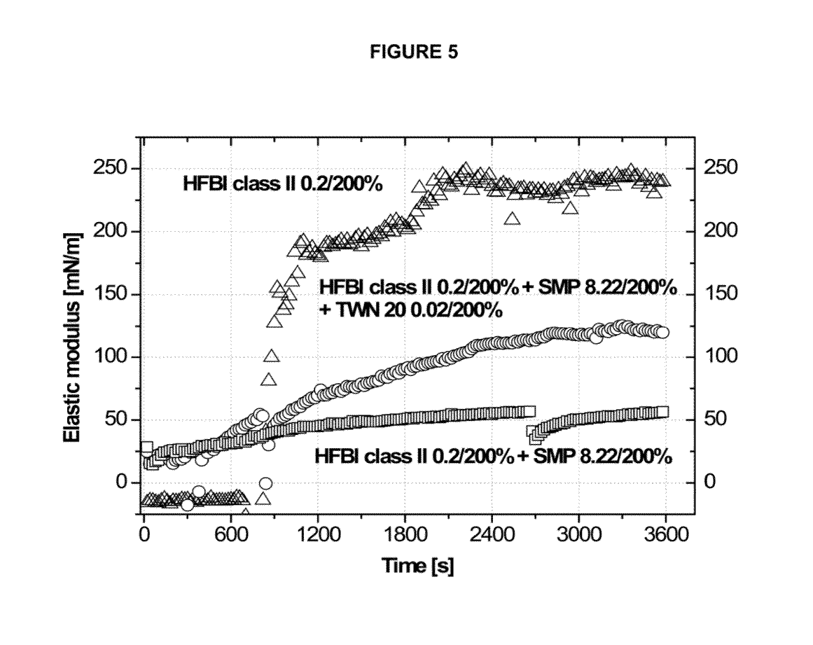

FIG. 5 shows the elastic interfacial modulus for pure Class II hydrophobin HFBI in water (top, triangles) at a concentration of HFBI=0.2/200 wt. %. The addition of SMP to such a solution at a concentration of 8.22/200 wt. % (bottom, squares) clearly reduces the elastic interfacial modulus of compared Class II hydrophobin HFBI alone. Addition of a CSF (middle, circles) to the SMP+Class II hydrophobin HFBI mix at a concentration of 0.02/200 wt. % promotes a recovery of the interfacial elasticity.

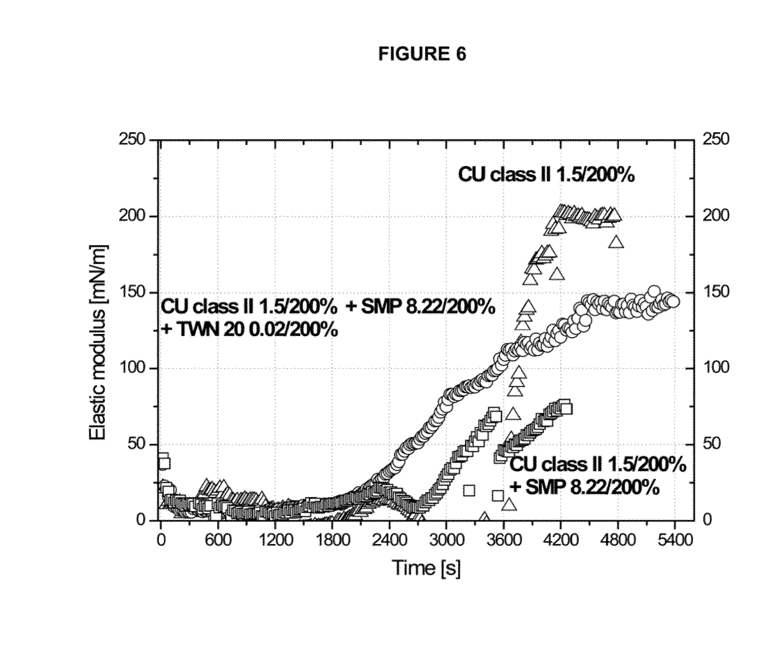

The same pattern is seen in FIG. 6 for CU, the other class II hydrophobin, although CU is active (top, triangles) at a higher concentration (1.5/200 wt. %) than the other hydrophobins. The addition of SMP (8.22/200 wt. %) clearly reduces the elastic interfacial modulus (bottom, squares) in comparison to value measured for Class hydrophobin CU alone (triangles). Addition of a CSF (middle, circles) to the SMP+Class II hydrophobin CU mix at a concentration of 0.02/200 wt. % promotes a recovery of the interfacial elasticity

These data demonstrate that the use of a Co-surfactant works with other class II hydrophobins.

### Example 7

### Stability of Foams at Chill Temperature in the Presence and Absence of a Preferred Level of Co-Surfactant

Chilled, aerated confections (D), (E), and (F) were made using formulations summarised in Table 7. A control formulation with no Co-surfactant (Cont) was also prepared. The relative amounts of hydrophobin, SMP, and Co-surfactant are selected from the examples measured in Example 3.

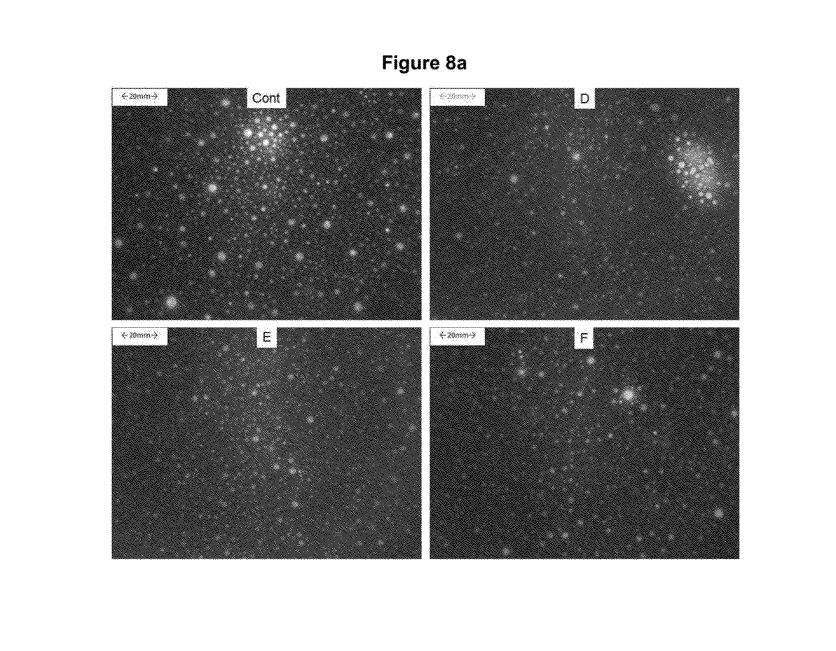

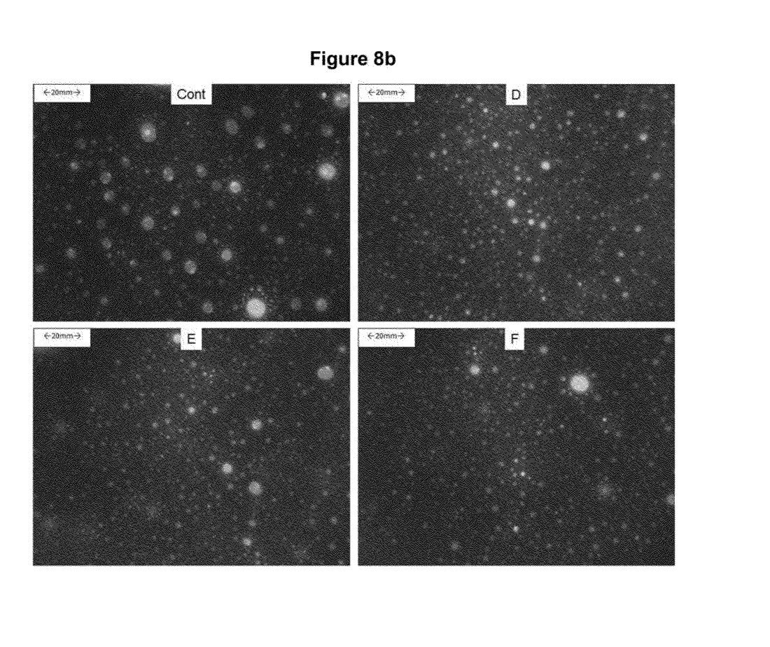

TABLE 7
Formulations of chilled aerated confections for macroscope
images shown in FIG. 8.

| | Cont | D | E | F |
|---|---|---|---|---|
| | Comparative | Inventive | Inventive | Inventive |
| Ingredient | Weight % | Weight % | Weight % | Weight % |
| Sucrose | 20.4 | 20.4 | 20.4 | 20.4 |
| Xanthan | 0.41 | 0.41 | 0.41 | 0.41 |
| SMP | 8.36 | 8.36 | 8.36 | 8.36 |
| HFBII | 0.05 | 0.05 | 0.05 | 0.05 |
| Tween 20 | — | 0.02 | — | — |
| Tween 50 | — | — | 0.02 | — |
| Panodan | — | — | — | 0.02 |
| Water | to 100% | to 100% | to 100% | to 100% |

The macrographs of the fresh and stored products D, E, and F, are shown in FIG. 8. Also shown are the images for the control samples (labelled Cent). FIG. 8a shows macroscope images of the foams prior to storage and FIG. 8b shows images of the foams after 4 weeks storage at chill temperature. From the images presented it can be seen that Products D, E and F have smaller air bubbles initially than the control sample (with no co-surfactant), and after storage, the differences between the test samples and the control are even greater in particular, we note that after storage. Products D, E, and F, show a much smaller proportion of bubbles>about 5 mm in diameter in comparison to the control.

Table 8 shows the changes in product volume with time for the inventive samples and the comparative example function of storage time. From Table 8 it can be seen that the samples containing a Co-surfactant at a preferred level have greater stability to overrun loss than the comparative example.

TABLE 8
Changes in product volume with storage time at chill temperature for
the inventive samples D, E and F and the comparative control sample.
The product volume decreases as overrun is lost.

| | Cont | D | E | F |
|---|---|---|---|---|
| | Comparative | Inventive | Inventive | Inventive |
| Product volume T = 0 | 100 | 100 | 100 | 100 |
| weeks; (cm³) | | | | |
| Product volume T = 1 | 97 | 98 | 100 | 100 |
| week (cm³) | | | | |
| Product volume T = 4 | 95 | 98 | 99 | 100 |
| weeks (cm³) | | | | |

It was found that tt recovery of the elastic modulus (Eₑ) for the inventive Co-surfactant containing solutions (shown in Examples 1 and 3) was associated with smaller foam bubble sizes initially and increased stability of the foam during storage in our inventive samples D, E and F.

### Example 8

### Surface Dilatational Modulus for a Range of Hydrophobin, Skim Milk Protein, and Co-Surfactant within the Inventive Range and Level Outside of the Inventive Range

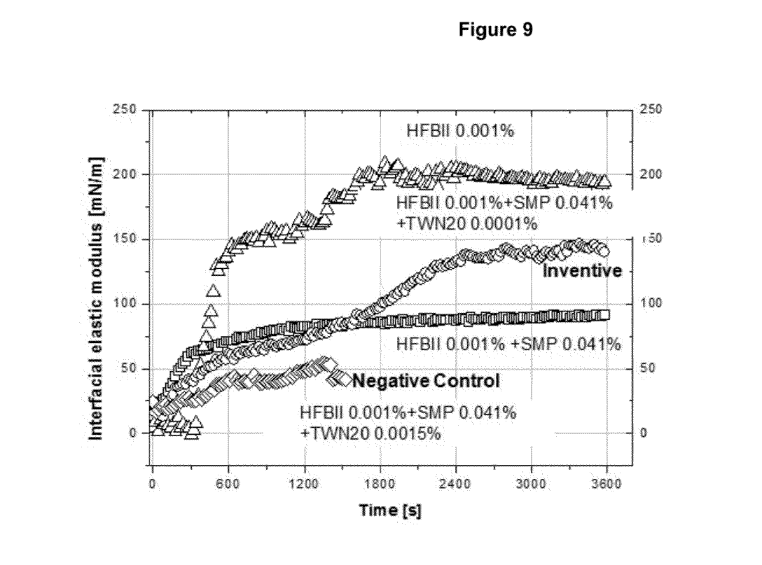

FIG. 9 shows how the dilational elastic surface modulus of a bubble varies with each composition using the same a dilational measurement technique as described in the Methods' section. The formulations used are given in Table 9.

TABLE 9
Formulations used for Example 8

| | A | B | C | |
|---|---|---|---|---|
| Ingredient | (reference) | (comparative) | (inventive) | Negative Test |
| HFBII | 0.001% | 0.001% | 0.001% | 0.001% |
| SMP * | — | 0.041% | 0.041% | 0.041% |
| Co-surfactant | — | — | 0.0001% | 0.0015% |
| Tween 20 | | | | |
| HFBII to Co- | — | — | 0.1 | 1.5 |
| surfactant | | | | |
| ratio | | | | |

* Concentration for SMR (skim milk powder) is that stated for the total powder. The amount of protein in SMP was stated by the manufacturer as 35 wt. %.

Addition of SMP reduced elasticity by over half. Addition of a co-surfactant at a level that lies within our claimed HFBII/co-surfactant ratio was found to unexpectedly improve the surface elasticity of HFBII in an HFBII/SMP mixture. However, if we use a higher level of Co-surfactant we are unable to produce a bubble that was stable enough to measure within the time window (1 hour) of the experiments. Table 10 shows the interfacial surface elasticity (Eₛₜ) for a sample within the preferred Co-surfactant range, sample C (Inventive), and a sample outside the preferred range (Negative Test). From the Table it may be seen that in the Negative Test sample case the bubble produced had a low elastic modulus and was very unstable

TABLE 10
Interfacial Elastic modulus (Eₑ) (mN/m) compared at defined
time points for cases shown in Example 8

| | 1200s | 1800s | 2400s | 3600s |
|---|---|---|---|---|
| Example A | 162.8 | 194.1 | 204.8 | 194.1 |
| (reference) | | | | |
| Example B | 82.2 | 85.9 | 87,2 | 91.4 |
| (comparative) | | | | |
| Example C | 72.1 | 95.6 | 133.1 | 140.2 |
| (inventive) | | | | |

| | | |
|---|---|---|
| Negative Test | 48.3 | bubble consistently lost before |
| | | end of experiment |

Therefore, we conclude that the selection of a Co-surfactant is not obvious and is not taught in the prior art. This is because Co-surfactants have to be used within our inventive ranges e.g. Co-surfactant Tween 20 in the Co-surfactant to HFBII ratio of 0.1 (inventive) provides a high Interfacial Elastic modulus of 140.2 mN/m but the same Co-surfactant in the Co-surfactant to HFBII ratio of 1.5 (the Negative Test sample) produced a low Interfacial Elastic modulus of 48.3 mN/m after 1200 seconds and the bubble becomes totally unstable after 1800 seconds.

### Example 9

### Stability of Foams at Chill Temperature in the Presence of a Co-Surfactant used at a Level that is Outside of the Inventive Range

Chilled, aerated confections were made using formulations described in Table 11. A control formulation with no Co-surfactant (Cont) was also prepared. The relative amounts of hydrophobia HFBII, SMP are the same as those selected for Example 8. However, the Co-surfactant level was selected to be outside of the preferred range for the Negative Test 2 sample.

TABLE 11
Formulation of chilled aerated confections for stability test of a Negative Test 2
sample, prepared with a Co-surfactant level outside of the inventive range

| | | Negative |
|---|---|---|
| | Cont | Test 2 |
| Ingredient | Weight % | Weight % |
| Sucrose | 20.4 | 20.4 |
| Xanthan | 0.41 | 0.41 |
| SMP | 8.36 | 8.36 |
| HFBII | 0.05 | 0.05 |
| Tween 20 | — | 0.3 |
| Water | to 100% | to 100% |

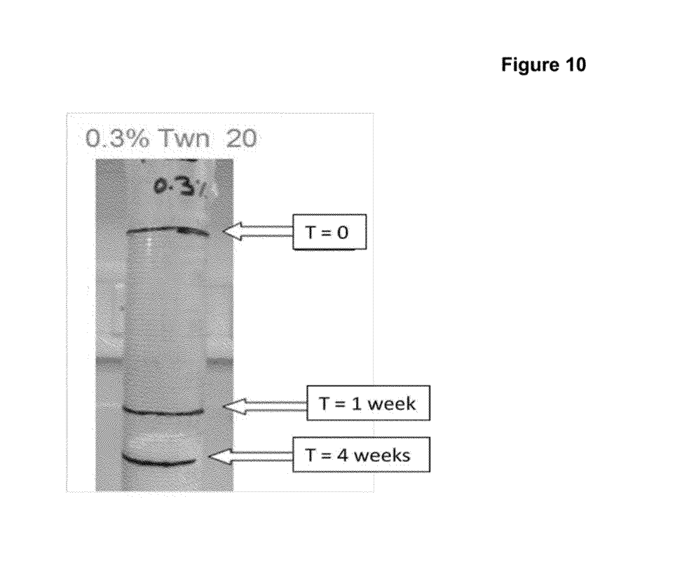

FIG. 10 shows a photograph of the aerated product prepared using a level of Co-surfactant that is outside of our preferred ranges. Inspection of the image clearly indicated that, this product is totally unstable. Table 12 shows the change in product volume with storage time at chill temperature. Inspection of the data in the Table 12 suggests that the foam is much less stable than the control sample.

TABLE 12
Variation of sample volume with time for the Comparative
Control sample (Cont) and the Negative Test 2 sample.

| | Cont | Negative |
|---|---|---|
| | Comparative | Test 2 |
| Product volume T = 0 weeks | 100 | 100 |
| (cm³) | | |
| Product volume T = 1 week | 97 | 65 |
| (cm³) | | |
| Product volume T = 4 weeks | 95 | 65 |
| (cm³) | | |

The product volume decreases as overrun is lost. The Negative Test 2 sample loses far more overrun on storage than the Comparative Control, the formulations for which are described in Table 11.

This result confirms that Co-surfactants type and level can only be selected reliably by using Our inventive method, and that was surprisingly discovered in the present invention,

### Test Methods and Material Sources:

### 1. Dilatational Surface Rheology Measurements

### Materials

Preparation of the solutions for the experimental work was done using the same ingredients as in the preparation of fully formulated products except that tap water was used to prepare ice creams. All other solutions were prepared in de-ionised water (18.2 MΩ cm). Concentrations of ingredients are expressed as weight %.

Solutions were prepared using combinations of hydrophobin, Secondary protein e.g. a milk protein, and an added Co-surfactant.

In the interfacial rheology experiments the concentration of used ingredients was scaled down 200-times with respect to the levels used in ice cream manufacturing. The concentrations used for interfacial rheology experiments are (as an example and not restricted to these):
HFBII=0.001 wt. %=0.2/200 wt. %
SMP=0.041 wt. %=8.22/200 wt. %
CSF=0.0001 wt. %32 0.02/200 wt. %

### 2. Interfacial Rheology Method

Reported values of the viscoelastic modulus (E) were measured using the Drop Shape tensiometer PAT-1 (Sinterface, Germany). The measuring configuration is that of a bubble emerging from a J-shaped capillary positioned inside the cell containing the solution. The PAT-1 tensiometer implements a feature allowing for an accurate control of the bubble interfacial area with the possibility of varying it during the measurement according to predetermined patterns. This feature is utilised for the measurement of the dilational viscoelasticity. Purely harmonic oscillations of the bubble interfacial area with small amplitude and frequency are imposed (immediately after the bubble formation) while the surface tension response, γ(t), is measured. From the amplitude of the two signals, A(t) and γ(t), and the phase shift between them, the elastic and viscous components of E are calculated. Amplitude and phase of the measured A(t) and γ(t) oscillatory signals are extracted by standard Fourier analysis techniques.

In the experiments reported here an air bubble of area A₀=18 mm² was formed at the tip of a J-shaped capillary in a glass cell containing about 27 ml of the solution. An area variation between 2.5 and 3.5% was imposed during oscillations at the frequency of 0.05 Hz and a temperature of 5° C., unless otherwise stated. A gentle nitrogen stream was directed onto the cell glass walls (front and back) to prevent air humidity condensation which obscures the cell field of view

### 3. Scanning Electron Microscopy (SEM) Method

The microstructure of each frozen product was visualised using Low Temperature Scanning Electron Microscopy (LTSEM). The sample was cooled to −80° C. on dry ice and a sample section cut. This section, approximately 5 mm×5 mm×10 mm in size, was mounted on a sample holder using a Tissue Tek:OCT™ compound (PVA 11 wt. %, Carbowax 5 wt. % and 85 wt. % non-reactive components). The sample including the holder was plunged into liquid nitrogen slush and transferred to a low temperature preparation chamber: Oxford Instrument CT1500HF. The chamber is under vacuum, approximately 10⁻⁴ bar, and the sample is warmed up to −90° C. Ice is slowly etched to reveal surface details not caused by the ice itself, so water is removed at this temperature under constant vacuum for 60 to 90 seconds. Once etched, the sample is cooled to −110° C. ending the sublimation, and coated with gold using argon plasma. This process also takes place under vacuum with an applied pressure of 10⁻¹ millibars and current of 6 milliamps for 45 seconds. The sample is then transferred to a conventional Scanning Electron Microscope (JSM 5600; JEOL LTD. Japan), fitted with an Oxford Instruments cold stage at a temperature of −160° C. The sample is examined and areas of interest captured via digital image acquisition software e.g. using the method described below.

### 4. Production of Frozen Aerated Confections

### Mix Preparation

Ice cream pre-mixes were prepared by adding the solid ingredients to hot water (>60° C.) with stirring to disperse. The pre-mix, was then heated to 80° C. with a plate heat exchanger, then homogenised at 140 bar pressure and pasteurised at 82° C. for 25 seconds. The mix was then cooled via a plate heat exchanger to 5° C. and held at this temperature (aging) for at least 2 hours before further processing. After the aging step and prior to the freezing process (below), concentrated hydrophobin solution and Co-surfactant was added to the mix with gentle stirring to disperse. When used in combination, concentrated hydrophobin solution was mixed with the Co-surfactant before adding to the mix.

### Aerated Frozen Confection Production

After aging the mixes were processed using an WCB MF75 (for small scale) or Hoyer KF 1000 (for large scale) freezer. All aerated products were produced at 100% overrun and extruded ca. −6° C. Frozen products were collected in 500 mL waxed paper cartons and hardened in a blast freezer at −35° C. for 2 hours before storage at −25° C.

### Storage of Frozen Products

Products stored at −25° C. are classed as “fresh” products since the microstructure is stable at this temperature and growth of bubbles and ice crystals will not be significant between the time of production and further analysis by SEM (<1 month).

“Temperature abused” products were transferred to a freezer wherein the temperature fluctuates between −20° C. and −10° C. over 24 hours as follows: 11 hours 30 mins at −20° C. followed by 30 mins at +10° C., then 11 hours 30 mins at −10° C. followed by 30 mins at +10° C. After 2 weeks abuse with daily temperature fluctuations as described above, the products were then transferred to a −25° C. freezer before further analysis.

### 5. Determination of Bubble Size Distribution of Frozen Products

The gas bubble size (diameter) distribution as used herein is defined as the size distribution obtained from the two dimensional representation of the three dimensional microstructure, as visualized in the SEM micrograph, determined using the following methodology.

Samples are imaged at 3 different magnifications (for reasons explained below), and the bubble size distribution of a sample is obtained from this set of micrographs in three steps:
1. Identification and sizing of the individual gas bubbles in the micrographs
2. Extraction of the size information from each micrograph
3. Combination of the data from the micrographs into a single size distribution

All of these steps, other than the initial identification of the gas bubbles, can conveniently be performed automatically on a computer, for example by using software such as MATLAB R2006a (MathWorks, Inc) software.

### Identification and Sizing of the Individual Gas Bubbles in the Micrographs

Firstly, a trained operator (i.e. one familiar with the microstructures of aerated systems) traces the outlines of the gas bubbles in the digital SEM images using a graphical user interface. The trained operator is able to distinguish gas bubbles from ice crystals (which are present in frozen aerated products and are the same order of magnitude in size) because the gas bubbles are approximately spherical objects of varying brightness/darkness whereas ice crystals are irregular-shaped objects of a uniform grey appearance.

Secondly, the size is calculated from the selected outline by measuring the maximum area as seen in the two dimensional cross-sectional view of the micrograph (A) as defined by the operator and multiplying this by a scaling factor defined by the microscope magnification. The bubble diameter is defined as the equivalent circular diameter d:

d=2\sqrt{A/π}

This is an exact definition of the diameter of the two-dimensional cross-section through a perfect sphere. Since most of the gas bubbles are approximately spherical, this is a good measure of the size.

Extraction of the Size Information from Each Micrograph

Gas bubbles which touch the border of a micrograph are only partially visible. Since it is not therefore possible to determine their area, they must be excluded. However, in doing so, systematic errors are introduced: (i) the number of gas bubbles per unit area is underestimated; and (ii) large gas bubbles are rejected relatively more often since they are more likely to touch the border, thus skewing the size distribution. To avoid these errors, a guard frame is introduced (as described in John C. Russ, “The Image Processing Handbook”, second edition, CRC Press, 1995). The guard frame concept uses a virtual border to define an inner zone inside the micrograph. The inner zone forms the measurement area from which unbiased size information is obtained, as illustrated in FIG. 6 (a schematic depiction of a micrograph, in which gas bubbles that touch the outer border of the micrograph have been drawn in full, even though in reality only the part falling within the actual micrograph would be observed.)

Bubbles are classified into 5 classes depending on their size and position in the micrograph. Bubbles that fall fully within the inner zone (labelled class 1) are included. Bubbles that touch the border of the virtual micrograph (class 2) are also included (since it is only a virtual border, there is fact full knowledge of these bubbles). Bubbles that touch the actual micrograph border (class 3) and/or fall within the outer zone (class 4) are excluded. The exclusion of the class 3 bubbles introduces a bias, but this is compensated for by including the bubbles in class 2, resulting in an unbiased estimate of the size distribution. Very large bubbles, i.e. those larger than the width of the outer zone (class 5), can straddle both the virtual (inner) border and the actual outer border and must therefore be excluded, again introducing bias. However, this bias only exists for bubbles that are wider than the outer zone, so it can be avoided by excluding all bubbles of at least this size (regardless of whether or not they cross the actual border). This effectively sets an upper limit to the gas bubble size that can be reliably measured in a particular micrograph. The width of the inner zone is chosen to be 10% of the vertical height of the micrograph as a trade-off between the largest bubble that can be sized (at the resolution of the particular micrograph) and the image area that is effectively thrown away (the outer zone).

There is also minimum size limit (at the resolution of the micrograph) below which the operator cannot reliably trace round gas bubbles. Therefore bubbles that are smaller than a diameter of 20 pixels are also ignored.

Combination of the Data from the Micrographs into a Single Size Distribution

As explained above, it is necessary to introduce maximum and minimum cut-off bubbles sizes. In order that these minimum and maximum sizes are sufficiently small and large respectively so as not to exclude a significant number of bubbles, some samples may need to be imaged at 3 different magnifications: e.g. 100×, 300× and 1000×. This occurs if there is a wide distribution in bubble sizes and the skilled user can determine what magnifications are appropriate in order to capture the full size distribution: one magnification or more. As an example for the case of 3 different magnifications, each magnification yields size information in a different range, given in Table 13.

TABLE 13

| Magnification | Minimum bubble size | Maximum bubble size |
|---|---|---|
| 100× | 20 μm | 83 μm |
| 300× | 6.6 μm | 28 μm |
| 1000× | 2.0 μm | 8.3 μm |

Thus bubbles as small as 2 μm and as large as 83 μm are counted. Visual inspection of the micrographs at high and low magnifications respectively confirmed that essentially all of the bubbles fell within this size range. The magnifications are chosen so that there is overlap between the size ranges of the different magnifications (e.g. gas bubbles with a size of 20-28 μm are covered by both the 100× and 300× micrographs) to ensure that there are no gaps between the size ranges. In order to obtain robust data, at least 500 bubbles are sized: this can typically be achieved by analysing one micrograph at 100× one or two at ×300 and two to four at ×1000 for each sample.

The size information from the micrographs at different magnifications is finally combined into a single size distribution histogram. Bubbles with a diameter between 20 μm and 28 μm are obtained from both the 100× and 300× micrographs, whereas the bubbles with a diameter greater than 28 μm are extracted only from the 100× micrographs. Double counting of bubbles in the overlapping size ranges is avoided by taking account of the total area that was used to obtain the size information in each of the size ranges (which depends on the magnification), i.e. it is the number of bubbles of a certain size per unit area that is counted. This is expressed mathematically, using the following parameters:

N=total number of gas cells obtained in the micrographs

dₖ=the k^{th} outlined gas cell with k ∈ [1, N]

Aᵢ=the area of the inner zone in the j^{th} micrograph

Rⱼ=the range of diameters covered by the i^{th} micrograph (e.g. [20 μm, 83 μm])

B(j)=the j^{th} bin covering the diameter range: [j W, (j+1)W)

The total area, S(d), used to count gas bubbles with diameter d is given by adding the areas of the inner zones (Aᵢ) in the micrographs for which d is within their size range (Rᵢ).

$$S ( d ) = {\sum }_{i \vert d ∈ {R}_{i}}^{ } {A}_{i}$$

The final size distribution is obtained by constructing a histogram consisting of bins of width W μm. B(j) is the number of bubbles per unit area in the j^{th} bin (i.e. in the diameter range j×W to (j+1)×W). B(j) is obtained by adding up all the individual contributions of the gas bubbles with a diameter in the diameter range j×W to (j+1)×W, with the appropriate weight, i.e. 1/S(d).

$$B ( j ) = {\sum }_{k ∈ D}^{ } 1 / S ( {d}_{k} )$$

$$where$$

$${D}_{j} = \{ k \vert {d}_{k} ∈ [ jW , ( j + 1 ) W ) \}$$

Magnifications used are chosen by the skilled user in order to extract bubble size through the analysis software.

The bubble size distributions are conveniently described in terms of the normalised cumulative frequency, i.e. the total number of bubbles with diameter up to a given size, expressed as a percentage of the total number of bubbles measured.

Alternative expressions of bubble size distribution can also be used, e.g. d3,2.

### 6. Preparation of Samples for Macroscope Analysis

### Sample Preparation

A transparent square container was used to contain a sample of each foam under investigation. The plastic container consisted of a hinge on one side and a catch on the opposing side. The edges of the container (≈1-2 mm thick) were coated with a thin layer of vacuum grease (Dow Corning) using a syringe before addition of a foam sample. Sufficient quantity of foam was used such that the container when closed was overfilled meaning surplus foam was ejected. The closed unit was then sealed with clear nail varnish around the container edges and left to dry. Three containers were set up for each foam sample. The weight of the containers was monitored over time—initial, 1, 4 and 6 weeks storage. This allowed a reliable estimate of any foam escaping from the container over time. This was proved to be minimal.

### Characterisation of Foams Using a Macroscope

The sample container was placed on the stage with the light used to illuminate the sample on full power. The image was obtained by appropriately focussing the lens and then subsequently adjusting the camera settings to obtain a high quality picture. The camera settings outlined blow allowed optimal imaging:
Exposure: 50-70 ms;
Gain: 2.0×;
Gamma: 2.00×;
Image type: Greyseale;
Captured format: 1728×1296, Interlaced Medium High Quality.

Each of the images produced had 20 mm scale bars on the top left hand corner of the image

7. Method for Bubble Size Analysis from Microscope Images

The gas bubble size (diameter) distribution as used herein is defined as the size distribution obtained from the two dimensional representation of the three dimensional microstructure, as visualized in the macrospopic images, determined using the following methodology.

The bubble size distribution of sample is obtained from this set of macrographs in three steps:
4. Identification and sizing of the individual gas bubbles in the micrographs
5. Extraction of the size information from each micrograph
6. Combination of the data from the micrographs into a single size distribution

All of these steps, other than the initial identification of the gas bubbles, can conveniently be performed automatically on a computer, for example by using software such as MATLAB R2006a (MathWorks, Inc) software or by a trained microscopist using a suitably calibrated scale bar.

### 8. Measurement of Overrun Volume Loss on Storage at Chill Temperature

100 cm³ of each foam was placed in a measuring cylinder. The measuring cylinder was then sealed using Parafilm® in order to prevent evaporative losses. The tubes were then stored at chill temperature. The height of the foam was recorded as a function of storage period.

### 9. Preparation of Aerated Chilled Confections.

### Preparation of Co-Surfactant Solutions

The following Co-surfactant solutions were prepared in advance as 1% solutions for the test samples or at 10% for the negative co-surfactant control sample. All dilutions were prepared using deionised water. The Tween 20 solutions were manually agitated in order to disperse (dissolve) the Co-surfactant, The Panodan solution once prepared was sonicated for 2-3 minutes at high power in a sonic bath to disperse, forming a milky solution. The Tween 60 solution was prepared by melting a sample of the stock solution and then adding the appropriate amount to D.I water, which had been heated to 70° C.

### Preparation of Stock SMP/Xanthan/Sucrose Solution

Dry xanthan (0.41% w/w) was mixed with sucrose (20.4% w/w) to aid dispersion of the xanthan. The mix was dissolved in water at 80° C. and stirred manually for 10 minutes. Having allowed the mix to cool to 70° C. SMP (8.36% w/w) was added gradually with stirring. The remaining water was then added to complete the formulation (to 1 kg) and the resulting solution sheared on a Silverson Mixer for 2-3 minutes. The solution was left to cool to room temperature and then stored at chill ready for use in foam preparation stage the following day.

### Aeration of Chilled Product

4 g of the Co surfactant solution was added to the hydrophobin (138 mg/g, 0.7246 g) and the mix stirred manually. The HFBII/co-surfactant mix was then combined with 200 g of the SMP/Xanthan/Sucrose mix and the resulting mix stirred. Aeration was carried out using a laboratory scale scraped surface heat exchanger operating at t 1000 rpm for 10 minutes. The equipment was cooled with circulating water at 5° C. 4 grams of a 5% phenoxethanol solution was then added as an antimicrobial and mixed into the foam at low speed (250 rpm for 30 s). The foam produced was decanted into Sterlin® pots prior to setting up samples for analysis.

The control foam was prepared by the same procedure except that deionised water was mixed with HFBII at the start (i.e. no co-surfacant added). The foam was decanted into Sterilin® pots prior to setting up samples for analysis.

All samples were prepared with an overrun of at least 100%,

### 10. Material Sources

| Ingredient | Source | Comments |
|---|---|---|
| Hydrophobin HFBII | Danisco, Denmark | Class II hydrophobin |
| Hydrophobin, HFBII | VTT, Finland | Class II hydrophobin |
| Hydrophobin, Cerato Ulmin | Unilever R&D Vlaardingen | Class II hydrophobin |
| Skim Milk Protein (SMP) | Dairy Crest | 35 wt. % protein content |
| Xanthan Keltro F | CP Kelco | Cold water soluble |
| Corn syrup LF9 | Brenntag | |
| Panodan Visco Lo 2000 | Danisco, Denmark | A diacetyl tartaric acid ester |
| | | of mono-diglycerides; |
| | | Sapnoification value 435- |
| | | 465; Add value 50-70; Iodine |
| | | value~75. |
| Tween 60: Polyoxyethylene | Sigma Chemicals | A water soluble (HLB = |
| (20) sorbitan monostrearate | | 14.7), low molecular weight, |
| | | non-ionic surfactant |
| Tween 20 Polyoxyethylene | Sigma Chemicals | A water soluble (HLB = |
| (20) sorbitan monolaurate | | 16.7), low molecular weight, |
| | | non-ionic surfactant |
| PGE-O-80/D | Danisco, Denmark | A polyglycerol ester: |
| | | polyglycerol moiety is mainly |
| | | di-, tri-, and tetraglycerol; |
| | | Iodine value~55; |
| | | Saponification value 115- |
| | | 135. |
| Sucrose ester SE1670 | Ryoto Sucrose Esters- | |
| | (Mitsubishi-Kagaku Foods) | |
| Sucrose ester SP70 | Ryoto Sucrose Esters- | Sucrose ester SP70 |
| | (Mitsubishi-Kagaku Foods) | |
| PGE55 | Danisco, Denmark | A polyglycerol ester; |
| | | polyglycerol moiety is mainly |
| | | di-, tri-, and tetraglycerol; |
| | | Iodine level max. 2; |
| | | Saponification value 130- |
| | | 145. |
| Hygel | Kerry Foods | Hydrolysed milk protein |
| Ice Structuring Protein | Martek | Ice Structuring Protein |
| (ISPIII) | | (ISPIII) |
| IcePro | Danisco | |

We claim:

1. A non-frozen aerated chill or ambient composition comprising:
a. at least 0.01 wt. % of total hydrophobin(s) selected from the group consisting of class hydrophobin(s), class II hydrophobin(s) or blends thereof added in isolated form to the food composition;
b. one or more Co-surfactant(s) in the total concentration range of about 0.001 to less than about 0.2 wt. %;
c. one or more Secondary protein(s) that are different from hydrophobin(s); wherein said Secondary protein(s) are present in a total concentration range of about 0.25 to less than about 6.0 wt. % and
d. wherein the ratio of Co-surfactant(s) to total hydrophobin(s) is in the range of about 0.02 to about 1.0.

2. The product of claim 1 wherein the hydrophobin(s) are class II hydrophobin(s) selected from the group consisting of HFBII, HFBI or Cerato Ulmin or blends thereof.

3. The product of claim 1 wherein the total hydrophobin(s) concentration is at most 1.5 wt. %.

4. The product of claim 1 wherein the Co-surfactant(s) is or are water soluble nonionic surfactant(s).

5. The product of claim 1 wherein the Co-surfactant(s) are selected from Polysorbates; polyglycerol esters of alkyl or alkenyl fatty acids, diacetyl tartartic acid esters of mono-/di- glycerides, sucrose esters with an HLB>about 8 or blends thereof.

6. The product of claim 1 wherein the Co-surfactant(s) has a minimum effective HLB value of about 8.

7. The product of claim 1 wherein the Co-surfactant(s) is selected from Tweens 20, 60 or 80, PGE-O-80; Panodan-Visco Lo 2000 and blends thereof.

8. The product of claim 1 wherein after 6 weeks storage at 5 C no more than 10 bubbles of a size greater than 10 mm in diameter are observed in a sample size of 9437 mm squared area where the sample is in a 6 mm deep container and had an initial overrun between 30 and 200% overrun.

9. The process of making a non-frozen aerated product comprising the steps of:
a. Blending the food composition ingredients together and mixing;
b. Adding at least 0.01 wt. % of hydrophobin(s) and Co-surfactant(s) in a total concentration range of about 0.001 to less than 0.2 wt % to the chilled mix of step (a);
c. Aerating the mix of step (b) to produce the aerated product;
d. wherein the ratio of Co-surfactant(s) to total hydrophobin(s) is in the range of about 0.02 to 1.0;
e. wherein the aerated product contains one or more Secondary protein(s) different from hydrophobin in a total concentration range of about 0.25 to less than 6.0 wt %, and;
f. wherein pasteurisation may be accomplished after step (a) and/or step (b).
